(19) United States
(12) Patent Application Publication
(10) Pub. No.: US 2018/0354313 A1
(43) Pub. Date: Dec. 13, 2018

(54) Tire Tread Comprising Incisions

(71) Applicant: COMPAGNIE GENERALE DES ETABLISSEMENTS MICHELIN, Clermont-Ferrand (FR)

(72) Inventors: Etienne BLANCHET, Clermont-Ferrand Cedex 9 (FR); Sébastien PICHOIR, Clermont-Ferrand Cedex 9 (FR)

(73) Assignee: COMPAGNIE GENERALE DES ETABLISSEMENTS MICHELIN, Clermont -Ferrand (FR)

(21) Appl. No.: 16/060,778

(22) PCT Filed: Dec. 7, 2016
(86) PCT No.: PCT/FR2016/053241

§ 371 Date: Jun. 8, 2018

(30) Foreign Application Priority Data
Dec. 13, 2015 (FR) 1502583

(51) Int. Cl. B60C 11/12; B60C 11/03; B60C 11/00

(52) U.S. Cl. CPC B60C 11/1281; B60C 11/0008; B60C 11/0323

(57) ABSTRACT

Tire tread (1) made of elastomeric material, having a tread surface intended to come into contact with a road surface when the tire rolls. The tread includes a plurality of cuts opening onto the tread surface, each cut having a sipe (3) delimited by facing first walls (4), and a widening zone (5) delimited by second walls (6) widening the sipe in the depth of the tread, the roughness of the first walls (4) being different from the roughness of the second walls (6) of material.

### TECHNICAL FIELD OF THE INVENTION

The present invention relates to a motor vehicle tire tread. It relates more particularly to a tire tread provided with sipes.

### PRIOR ART

The document EP1015261 describes a tread pattern for a tread and more particularly a tread pattern that changes as the tread wears down. Moreover, according to one particular embodiment, the document presents a block provided with a channel, the profile of which is 0-shaped or droplet-shaped. This channel communicates with a sipe, which extends as far as the tread. This sipe follows a route forming a succession of broken lines.

The document EP0564435 presents a tire tread provided with profiling elements such as blocks, ribs extending in the peripheral direction, or similar configurations which are provided with thin siping cuts and/or grooves, the mutually opposite wall regions of which have a three-dimensional structure that differs at least in part on account of the presence of edges and surfaces respectively having a protrusion or setback, and do not extend parallel to one another, at least in part, wherein the wall regions have mainly set-back surface elements which form an acute angle with the travel surface, the set-back surface elements of one of the walls being arranged, with respect to the direction of the route of the thin cuts, in the opposite direction to these other walls.

The two arrangements described above are relatively complex and involve complicated manufacturing processes with expensive tooling.

The document WO03033281 for its part describes a tire tread made of elastomeric material, this tread being provided with a plurality of sipes, each sipe being delimited by facing walls, at least one of the walls delimiting each sipe having, on its entire surface, a mean roughness of between 1/100 and 1/10 of the width of the sipe, said tread comprising at least one of the walls delimiting each sipe, having at least one first set and a second set of lines of raised patterns with respect to said wall and having a maximum height, measured perpendicularly to said wall, at least equal to 1/10 of the width, each set of lines having a plurality of lines extending in one and the same direction, each line of each set crossing the surface from one edge to another edge of this surface, the lines of the first set intersecting the lines of the second set. This design aims to increase the blocking effect between the walls of the sipes. However, the production of the lines of patterns requires a complex mould, with moulding/demoulding operations that are not very easy and expensive.

The invention provides various technical means for remedying these various drawbacks.

### SUMMARY OF THE INVENTION

First of all, a first object of the invention consists in providing a tire tread that makes it possible to optimize braking characteristics.

A further object of the invention consists in providing a tire tread that makes it possible to reduce the braking distance on snow-covered ground.

A further object of the invention consists in providing a tire tread that affords an improved braking distance on dry ground.

Finally, a further object of the invention consists in providing a tire tread that favours the evacuation of water when driving in the rain.

To this end, the invention provides a tire tread made of elastomeric material, having a tread surface intended to come into contact with a road surface when said tire rolls, said tread comprising a plurality of cuts opening onto the tread surface, each cut having a sipe delimited by facing first walls, and a widening zone delimited by second walls widening said sipe in the depth of the tread, the roughness of the first walls being different from the roughness of said second walls of material.

With such a design, the difference in roughness between the first walls and the second walls makes it possible to optimize the braking characteristics on snow-covered ground.

According to a first embodiment, the roughness index of said first walls is less than the roughness index of said second walls. For example, the roughness corresponds to a mean roughness deviation RA, and the roughness RA1 of the first walls is between 0.05 μm and 1 μm, preferably between 0.1 μm and 0.3 μm, and the roughness RA2 of said second walls is between 4 μm and 50 μm, preferably between 6 μm and 15 μm.

The roughness advantageously corresponds to a mean profile height Rz, and the roughness Rz1 of the first walls is between 0.1 μm and 5 μm and the roughness RA2 of said second walls is between 12 μm and 150 μm.

With such a design, the braking characteristics on snow are improved. Specifically, the notably low roughness index of said first walls combined with the presence of a widening favours sliding of these walls against one another. During the application of a braking force, this sliding causes one of the walls to rise with respect to the other, making it possible to grip the snow and thus to reduce the braking distance.

Moreover, this design allows the braking characteristics to be maintained, even when the tires are worn. Specifically, when the tread pattern elements are worn away such that the first walls disappear, the microroughnesses of the second walls make it possible to store snow which, in contact with the snow on the ground, makes it possible to afford a reduction in the braking distance.

According to a second embodiment, the roughness of said first walls is greater than the roughness of said second walls.

The roughness advantageously corresponds to a mean roughness deviation RA, and the roughness RA1 of the first walls is between 4 μm and 50 μm, preferably between 6 μm and 15 μm, and the roughness RA2 of the second walls is between 0.05 μm and 1 μm, preferably between 0.1 μm and 0.3 μm.

The roughness advantageously corresponds to a mean profile height Rz, and the roughness Rz1 of the first walls is between 12 μm and 150 μm and the roughness Rz2 of said second walls is between 0.1 μm and 5 μm.

Such a design allows better braking on dry ground. Specifically, since the first walls are less mobile with respect to one another on account of the notably high roughness, during the application of braking forces, the tread pattern elements afford improved braking effectiveness on dry ground.

Moreover, when the tire is worn, the lower roughness of the second walls allows better evacuation of water and optimized braking on wet ground.

According to another variant embodiment, the profile of the widening zone is substantially droplet-shaped.

Advantageously, the transition zone between the first and second walls is curved with a radius of curvature of less than 0.5 mm.

This transition makes it possible to improve the wear pattern when the widening appears at the surface of the tread on account of the tire wearing away.

The invention also provides a tire having a tread as described above.

### DESCRIPTION OF THE FIGURES

All the embodiment details are given in the description which follows, which is supplemented by FIGS. 1 to 4, which are given solely by way of non-limiting examples and in which:

FIG. 1 is a cross-sectional view of a portion of tread according to the invention;

FIG. 2 is a cross-sectional view of a wall having a notably high roughness index;

FIG. 3 illustrates the measuring mode for the roughness denoted Rz;

FIG. 4 illustrates the measuring mode for the roughness denoted RA.

### DETAILED DESCRIPTION OF THE INVENTION

### Definitions

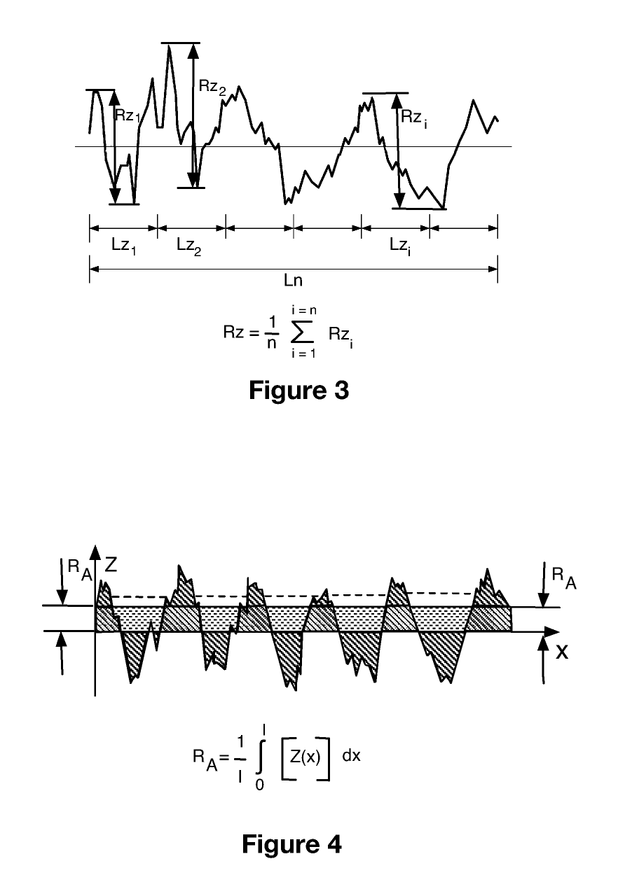

In order to calculate the roughness Rz of a surface, a given length of the surface to be evaluated, referred to as evaluation length Ln, is cut into n base lengths Lz of identical length, as is illustrated in FIG. 3. On each of these base lengths, an individual profile height Rzi, which is the sum of the greatest of the protruding heights and the greatest of the recessed depths of the profile of the surface within the base length Lzi, is determined. The mean height Rz is the arithmetic mean of the individual values Rzi over all of the base lengths considered (standard DIN 4768; 1990) and is expressed by the following formula:

$$Rz = \frac{1}{n} {\sum }_{i = 1}^{i = n} {Rz}_{i}$$

In order to calculate the roughness RA of a surface, RA: is the arithmetic mean of all the ordinates of the profile within the base length, as is illustrated in FIG. 4, according to the following formula:

$${R}_{A} = \frac{1}{l} {\int }_{0}^{l} [ Z ( x ) ] dx$$

A “tire” means all types of resilient tread, whether or not it is subjected to an internal pressure.

A “block” on a tread means a raised element delimited by recesses or grooves and comprising lateral walls and a contact face, the latter being intended to come into contact with a road surface during rolling.

The “tread” of a tire means a quantity of rubbery material delimited by lateral surfaces and by two main surfaces, one of which is intended to come into contact with a road surface when the tire is being driven on.

A “cut” denotes either a groove or a sipe and corresponds to the space delimited by walls of material that face one another and are at a non-zero distance from one another. What differentiates a sipe from a groove is the value of this distance: in the case of a sipe, this distance is suitable for allowing the opposing walls to come into contact when the sipe enters the contact patch in which the tire is in contact with the road surface. This distance for a sipe is in this case at most equal to two millimetres (mm). In the case of a groove, the walls of this groove cannot come into contact with one another under usual rolling conditions.

A “sipe” means a cut in the tread delimiting walls of material, the width of this cut being suitable for allowing the walls of the sipe to come at least partially into contact as they pass through the contact patch in which the tire is in contact with the ground. The width of a sipe is less than or equal to 2 millimetres.

The main direction of a sipe corresponds to the mean direction passing through the farthest-apart points of the sipe on the tread surface of the tread in the new, unworn state. The secondary direction is defined as the direction of a sipe perpendicular to the main direction and extending into the thickness of the tread.

A “groove” means a cut in which the distance between the walls of material is such that these walls cannot come into contact with one another under usual rolling conditions.

A “radial direction” means a direction which is perpendicular to the axis of rotation of the tire (this direction corresponds to the direction of the thickness of the tread).

An “axial direction” means a direction parallel to the axis of rotation of the tire.

A “circumferential direction” means a direction tangential to any circle centred on the axis of rotation. This direction is perpendicular both to the axial direction and to the radial direction.

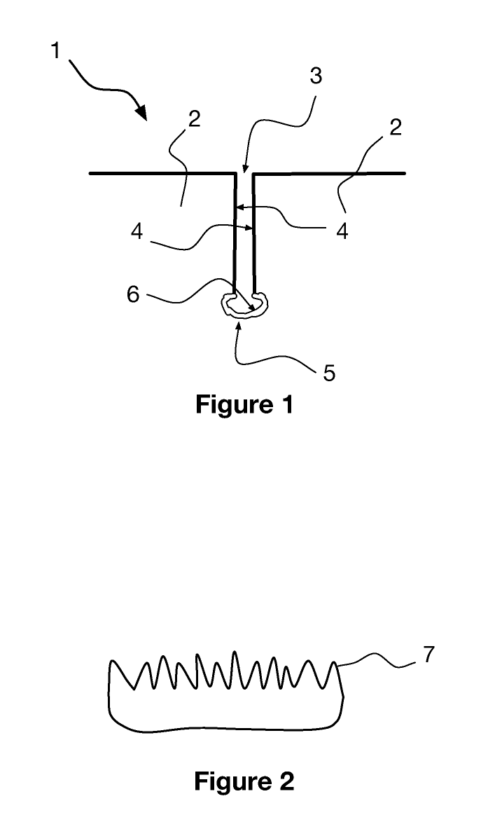

FIG. 1 illustrates an exemplary embodiment of an enlarged portion of a tire tread 1 having tread pattern elements 2. The tread 1 comprises a plurality of cuts that open onto the tread surface. The schematic cross section of the tread 1 in FIG. 1 clearly shows the zones of the cuts. Thus, a cut has a sipe 3 delimited by first walls 4 arranged in a manner facing one another. These walls 4 are substantially parallel. In the depth of the cut, away from the tread surface, the cut has a widening zone 5. This widening zone is delimited by second walls 6, at least a portion of which contributes towards creating a widening of the sipe 3.

The roughness of the first walls 4 is different from the roughness of the second walls 6. This characteristic has a number of variants. Thus, according to a first embodiment, the roughness of said first walls 4 is less than the roughness of the second walls 6, i.e. than the walls of the widening zone 5. In a second embodiment, the configuration is reversed, such that the roughness of the first walls 4, or the walls of the sipe 3, is greater than the roughness of the second walls 6, or the walls of the widening zone 5.

FIG. 2 schematically illustrates an example of microroughness elements 7 such as those present in the different zones of the cut. As can be seen, the roughness profiles are not uniform. In order to assess the roughness characteristics precisely and rigorously, data for roughness RA and roughness Rz have been established, in accordance with the definitions of these two types of roughness measurement set out above.

By way of non-limiting example, values of roughness RA and Rz are provided for the first and second walls, in order to properly represent the different roughness levels.

According to a first approach, the roughness RA of the walls of lower roughness is between 0.05 μm and 1 μm, and more preferably between 0.1 μm and 0.3 μm. The roughness RA of the walls of greater roughness is between 4 μm and 50 μm, preferably between 6 μm and 15 μm.

According to a second approach, the roughness Rz of the walls of lower roughness is between 0.1 μm and 5 μm, and the roughness Rz of the walls of greater roughness is between 12 μm and 150 μm.

A variety of variant embodiments are also included within the scope of the present invention. According to one exemplary embodiment, the roughness varies in a substantially progressive manner between the starting zone of the sipe and the widening zone 5. Such an arrangement confers good performance on snow-covered ground on the tire, both in the new state, on account of the tread patterns, and once the tread patterns are worn away. Specifically, in the latter case, the high level of roughness of the widening zone provides the effect of grip.

According to another variant embodiment, the roughness of the walls of the sipe varies with an alternation of zones of greater roughness, and then of lower roughness, etc., from the top to the bottom of the sipe. This arrangement makes it possible to properly adapt the level of friction between the walls. The greater the height of the block of rubber, the more it can deform and exhibit mobility. It is thus necessary to increase the roughness in the upper part of the walls in order to keep the blocks relative to one another. Once worn, the block is more rigid and less subject to deformation and mobility. Therefore, less roughness is required at depth.

In one non-limiting variant embodiment, the roughness varies laterally over the walls of the blocks of rubber.

According to another variant embodiment, zones of greater roughness are disposed facing zones of lower roughness. This disposition reduces the phenomena of meshing between the faces and makes it possible to store a small quantity of water between the spaces created between the two faces by the differences in roughness. This arrangement makes it possible to improve wet braking by reducing viscoplaning.

All the combinations of roughness on a wall of a block are possible.

In the same way, all the combinations of roughness between two walls delimiting a sipe 3 are possible.

According to another variant embodiment, the sipe walls are designed with an alternation of undulating zones and substantially flat zones. According to one exemplary embodiment, the substantially flat zones have greater roughness than the undulating zones. A reverse design, in which the undulating zones have greater roughness than the substantially flat zones, is also provided.

The invention is not limited to the examples described and shown and various modifications can be made thereto without departing from its scope.

### REFERENCE NUMERALS EMPLOYED IN THE FIGURES

1 Tread
2 Tread pattern elements
3 Sipes
4 First wall
5 Widening zone
6 Second wall
7 Microroughness elements

1. A tire tread made of elastomeric material, having a tread surface adapted to come into contact with a road surface when said tire rolls, said tread comprising a plurality of cuts opening onto the tread surface, each cut having:
a sipe delimited by facing first walls; and
a widening zone delimited by second walls widening said sipe in the depth of the tread;
wherein the roughness of the first walls is different from the roughness of said second walls.

2. The tire tread according to claim 1, wherein the roughness of said first walls is less than the roughness of said second walls.

3. The tire tread according to claim 1, wherein the roughness corresponds to a mean roughness deviation RA, and the roughness RA1 of the first walls is between 0.05 μm and 1 μm, and the roughness RA2 of said second walls is between 4 μm and 50 μm.

4. The tire tread according to claim 1, wherein the roughness corresponds to a mean profile height Rz, and the roughness Rz1 of the first walls is between 0.1 μm and 5 μm and the roughness RA2 of said second walls is between 12 μm and 150 μm.

5. The tire tread according to claim 1, wherein the roughness of the first walls is greater than the roughness of the second walls.

6. The tire tread according to claim 5, wherein the roughness corresponds to a mean roughness deviation RA, and the roughness RA1 of the first walls is between 4 μm and 50 μm, and the roughness RA2 of the second walls is between 0.05 μm and 1 μm.

7. The tire tread according to claim 5, wherein the roughness corresponds to a mean profile height Rz, and the roughness Rz1 of the first walls is between 12 μm and 150 μm and the roughness Rz2 of said second walls is between 0.1 μm and 5 μm.

8. The tire tread according to claim 1, wherein the profile of the widening zone is substantially droplet-shaped.

9. The tire tread according to claim 1, wherein the transition zone between the first and second walls has a radius of less than 0.5 mm.

10. The tire comprising a tread according to claim 1.

11. The tire tread according to claim 1, wherein the roughness corresponds to a mean roughness deviation RA, and the roughness RA1 of the first walls is between 0.1 μm and 0.3 μm, and the roughness RA2 of said second walls is between 6 μm and 15 μm.

12. The tire tread according to claim 5, wherein the roughness corresponds to a mean roughness deviation RA, and the roughness RA1 of the first walls is between 6 μm and 15 μm, and the roughness RA2 of the second walls is between 0.1 μm and 0.3 μm.
